(19) United States
(12) Patent Application Publication
(10) Pub. No.: US 2016/0109057 A1
(43) Pub. Date: Apr. 21, 2016

(54) ANGULAR POSITIONING APPARATUS

(71) Applicant: Creative Digital Systems Integration, Inc., Simi valley, CA (US)

(72) Inventor: Anand Kelkar, Northridge, CA (US)

(21) Appl. No.: 14/887,148

(22) Filed: Oct. 19, 2015

Related U.S. Application Data
(60) Provisional application No. 62/066,317, filed on Oct. 20, 2014.

(51) Int. Cl. F16M 13/02; G03B 17/56; F16L 3/26; H02K 7/14; F16L 3/015

(52) U.S. Cl. CPC F16M 13/02; H02K 7/14; F16L 3/015; F16L 3/26; G03B 17/561; F16M 2200/06

(57) ABSTRACT

An angular positioning apparatus that includes a wedge assembly and a rod assembly positioned generally within the wedge assembly. The wedge assembly can include a plurality of serially connected wedges, each separately rotatable and when rotated rotating the wedge or wedges, if any, above it. The rod assembly can be connected to the wedge assembly such that a distal end of the rod assembly has an operative pointing direction for a payload (an antenna, a camera, a laser or other angular sensitive device) mountable to a distal end of the apparatus) that is controllably movable by the wedge assembly and such that the rod assembly does not twist about a longitudinal axis thereof as the wedges are rotated. The rod assembly can form a hollow tube for wires and cables, or it can form a solid shaft.

### CROSS-REFERENCE TO RELATED APPLICATIONS

This application claims the filing date benefit of U.S. provisional application No. 62/066,317, filed Oct. 20, 2014, and whose entire contents are hereby incorporated by reference.

### BACKGROUND

The present disclosure relates to angular positioners, and particularly electro-mechanical positioners that can position their payloads, such as antenna systems or video systems, to any angular position in a hemisphere. This positioning function can be used, for example, when an antenna or video system is following or tracking the angular path of a moving vehicle.

### SUMMARY

This section provides a general summary of the disclosure and one or more of its advantages, and is not a comprehensive disclosure of the full scope of all of the features, of all of the alternatives or embodiments or of all of the advantages.

Disclosed herein is a positioning apparatus for a payload such as an antenna, a camera, a laser or other angular sensitive device. The positioning apparatus can include a wedge assembly and a rod assembly positioned generally within the wedge assembly. The wedge assembly can include a plurality of serially connected wedges, the bottommost of which is rotatable relative to a support for the positioning apparatus, and rest of which are rotatable relative to the wedge directly beneath it. The rod assembly can be connected to the wedge assembly such that (a) a distal end of the rod assembly has an operative pointing direction movable by the wedge assembly and corresponding to a pointing direction of a distal end of the wedge assembly as one or more of the wedges are rotated and positionable through all angles within a solid angle and (b) the rod assembly does not twist about a longitudinal axis thereof as the wedges are rotated.

The solid angle mentioned in the paragraph above can be a hemisphere or more than a hemisphere that includes, as an example only, between generally ten and thirty degrees below the horizon and across all azimuth angles. A value within that range can be fifteen degrees.

Also disclosed herein is a wedge assembly that includes a plurality of serially connected wedges, the bottommost of which is rotatable relative to a support for the positioning apparatus, and rest of which are rotatable relative to the wedge directly beneath it. The plurality of wedges, as an example only, can comprise three wedges, each having a thirty-five degree angle.

Additionally disclosed herein is a rod assembly positionable generally within a mechanical positioning assembly and connected thereto such that (a) a distal end of the rod assembly has an operative pointing direction movable by the positioning assembly and corresponding to a pointing direction of a distal end of the positioning assembly and positionable through all angles within a solid angle and (b) the rod assembly does not twist about a longitudinal axis thereof as the positioning assembly positions it. The rod assembly can form a torque tube through which wires, cables and the like can pass.

Referring to the paragraph above, the rod assembly can include a plurality of serially-connected rod segments, each connected to an adjacent one of the rod segments so as to allow relative motion only about a local set of x, y and z Cartesian axes. The “local set” is defined as the x-y plane being situated on the distal end of the previous wedge, centered at the point of connection of the previous rod assembly, and the z axis emanating orthogonally from the distal end of the previous wedge.

The above-mentioned torque tube is centered within the wedge assembly and can have, as an example only, a diameter of generally between 5% and 95% of the diameter of the wedge. The torque tube can provide torsional stasis between a payload of the positioning apparatus and a stationary mounting surface of the positioning apparatus. Additionally or alternatively, the torque tube can house electrical, optical and/or electromagnetic connection media on its path between a payload of the positioning apparatus and a source/terminus such as a servo-motor amplifier, laser, Radio Frequency Receiver or Power Amplifier.

Further disclosed herein are methods of operating a positioning apparatus for antenna or video systems and which does not need a rotary joint (or a slip ring) to carry electrical, optical and/or electromagnetic signals between a payload and a source/terminus.

### BRIEF DESCRIPTION OF THE DRAWINGS

The drawings described herein are for illustrative purposes only of selected aspects of the present teachings and not all possible implementations, and are not intended to limit the scope of the present teachings.

FIG. 1A is an elevational view showing an angular positioning apparatus of the present disclosure in an operable position mounted on a boat or other water vessel, and covered with a protective sleeve.

FIG. 1B is an enlarged view of the positioning apparatus of FIG. 1A illustrated in isolation.

FIG. 1C is a schematic view illustrating the controllable angular movement of the three wedges of the apparatus of FIG. 1B.

FIG. 1D is a simplified view of the positioning apparatus of FIG. 1B showing the wedges and thereby the payload in a first position and orientation.

FIG. 1E is a view similar to FIG. 1D showing the wedges with the middle wedge rotated and thereby the payload in a second position and orientation.

FIG. 2 is a view similar to FIG. 1B but with the protective sleeve removed of a first embodiment of the positioning apparatus in the first position of FIG. 1D.

FIG. 3 is a view similar to FIG. 2 of the first embodiment in a second position similar to FIG. 1E.

FIG. 4 is a view similar to FIG. 3 of the first embodiment in a third position with the top wedge rotated.

FIG. 5 is a view similar to FIG. 4 of the first embodiment in a fourth position with the middle wedge rotated.

FIG. 6 is an enlarged view taken on circle 6 of FIG. 2.

FIG. 7 is an alternate enlarged view taken of circle 7 of FIG. 2.

FIG. 8 is a cross-sectional view taken on line 8-8 of FIG. 6.

FIG. 9 is a cross-sectional view taken on line 9-9 of FIG. 3.

FIG. 10 is a view of a lower portion of the first embodiment of FIG. 2 showing the motor of the bottom wedge and with the gears meshing on the torque tube.

FIG. 11 is a view similar to FIG. 10 but showing the first embodiment with the bottom wedge rotated with the gear meshing on the torque tube.

FIG. 12 is a view similar to FIG. 1D of a second embodiment of the positioning apparatus and showing the internal components and the notional wire hook-ups.

FIG. 13 is an enlarged cross-sectional view taken on line 13-13 of FIG. 12.

FIG. 14 is an enlarged cross-sectional view taken on line 14-14 of FIG. 13.

FIG. 15 is a perspective view taken on circle 15 of FIG. 12.

FIG. 16 is a stylized view of the second embodiment showing the mounting brackets in isolation and without the torque tube members.

FIG. 17A is an enlarged cross-sectional view of the center of the bracket of FIG. 13 and taken on line 17-17 of FIG. 13; in this embodiment, the cables, wires and other connections are seen to pass through the torque tube.

FIG. 17B is a view similar to FIG. 17A showing an alternative arrangement where the torque tube is embodied as a solid shaft, and the wires and other connections are shown to run alongside the shaft.

FIG. 18 is a view similar to FIG. 12 but of a third embodiment of the positioning apparatus of the disclosure.

FIG. 19 is an enlarged view taken on circle 19 of FIG. 18, with the meshing gears at the edges of the torque tube segments ensure torsional stasis through all the segments of the torque tube.

FIG. 20 is view similar to FIG. 19 showing an alternative connection, which can be used, for example, when the rod is a solid shaft.

FIG. 21 is an enlarged perspective view taken on circle 21 of FIG. 18.

FIG. 22 is an enlarged cross-sectional view taken on line 22-22 of FIG. 21.

FIG. 23 is an electrical schematic for the first embodiment.

FIG. 24 is an electrical schematic for the second and third embodiments.

### DETAILED DESCRIPTION

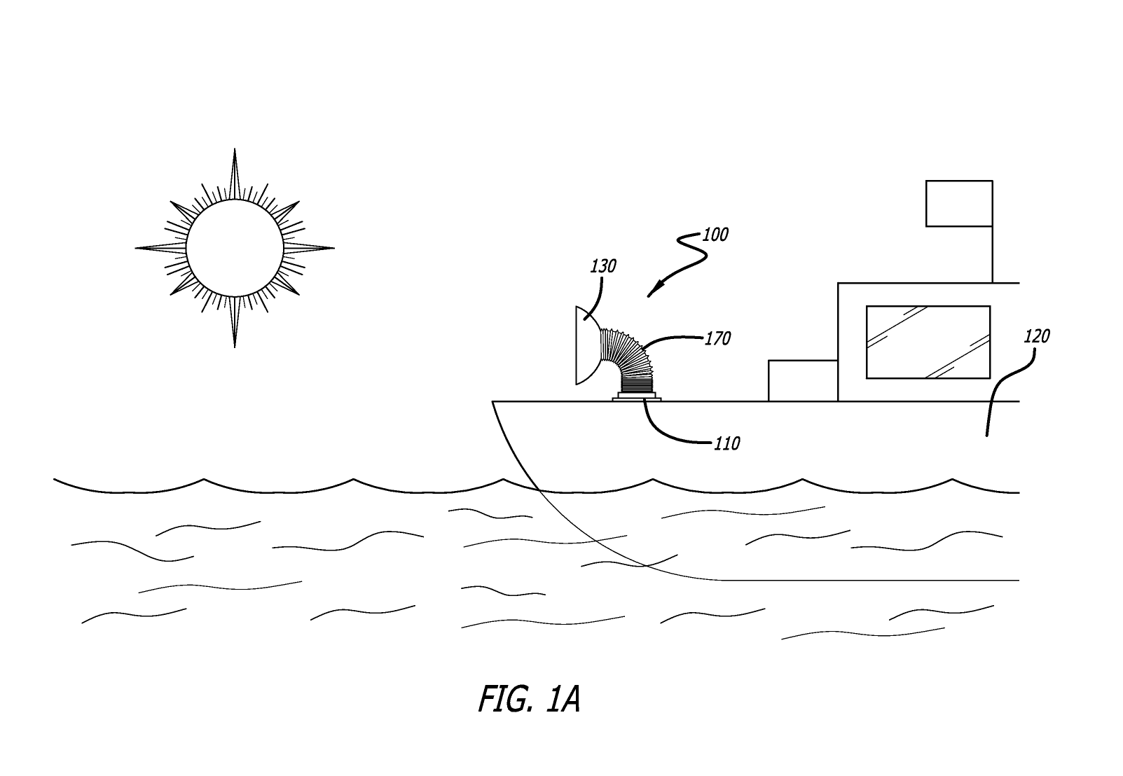

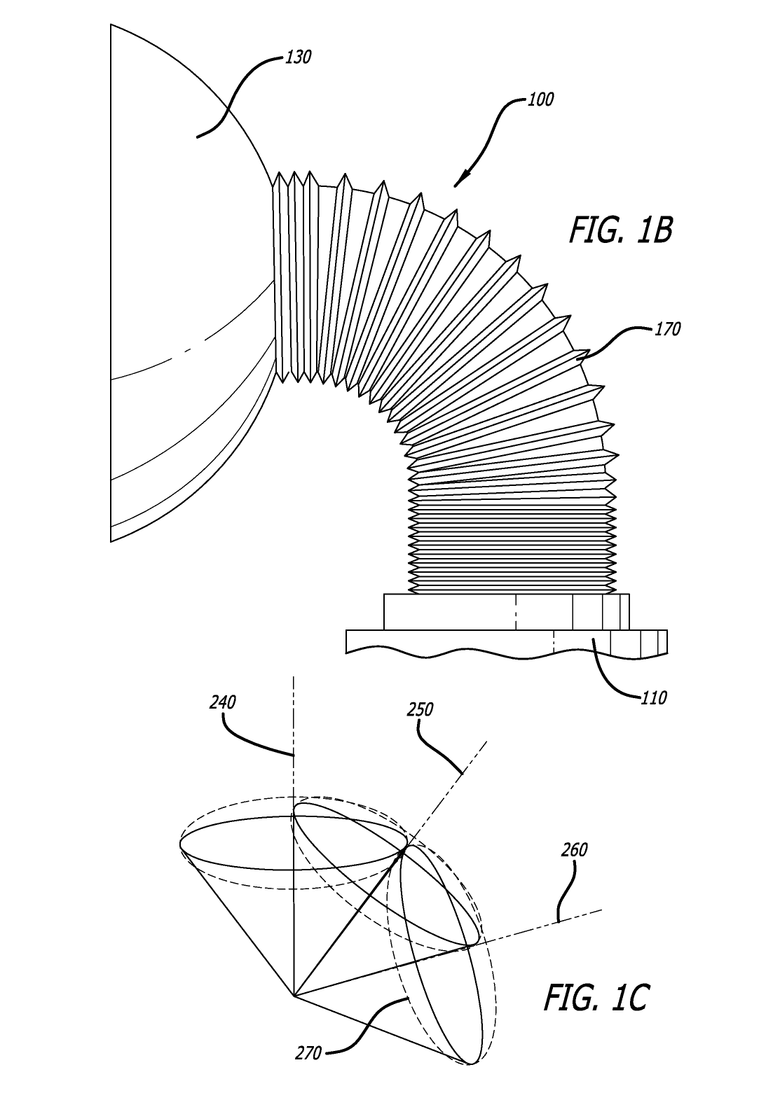

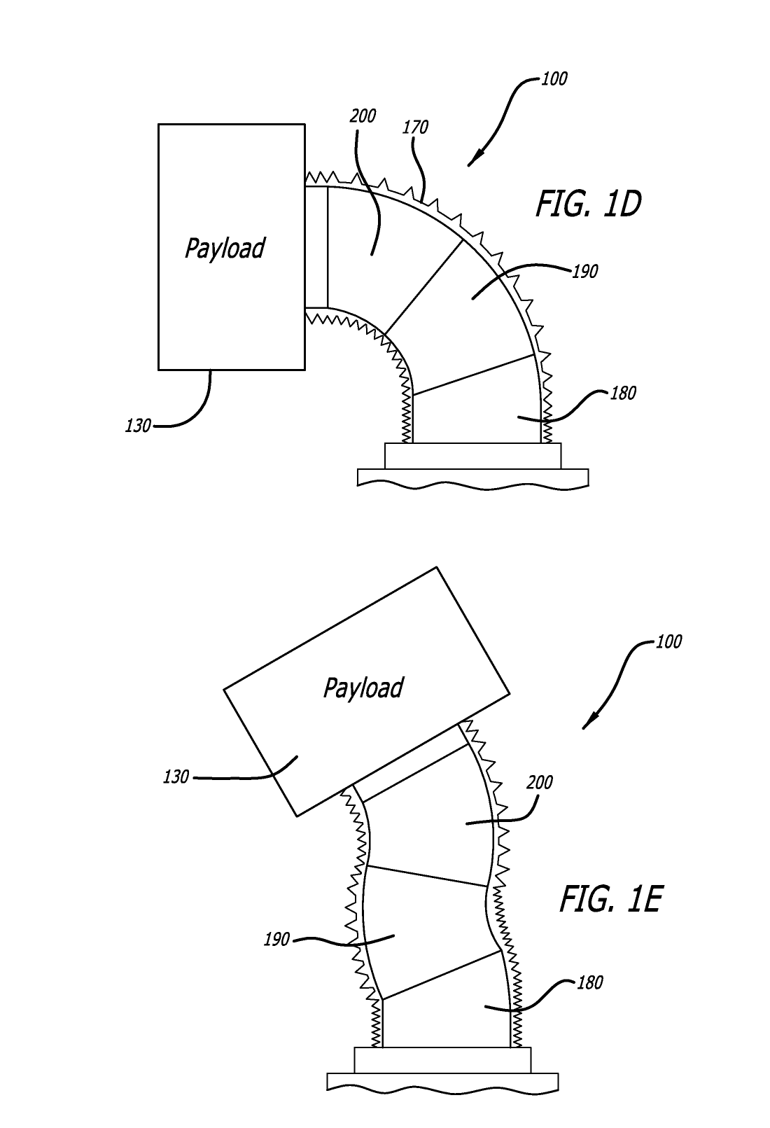

A three-axis angular positioning apparatus of the present disclosure is shown generally at 100 in FIG. 1 mounted on a pedestal 110 or the like which is mounted on a support surface. In this figure the support surface is illustrated to be a floating vessel 120, or its deck. The positioning apparatus 100 is shown supporting a payload 130 at the distal end thereof and controlling the pointing direction of the payload within a solid angle. The solid angle can be at least a hemisphere, or even an additional fifteen degrees below the horizon and across all azimuth angles. In this figure, the payload is shown to be an antenna, but it can be generally any angular sensitive device including a camera or laser. The payload 130 is shown generically in FIGS. 1D and 1E.

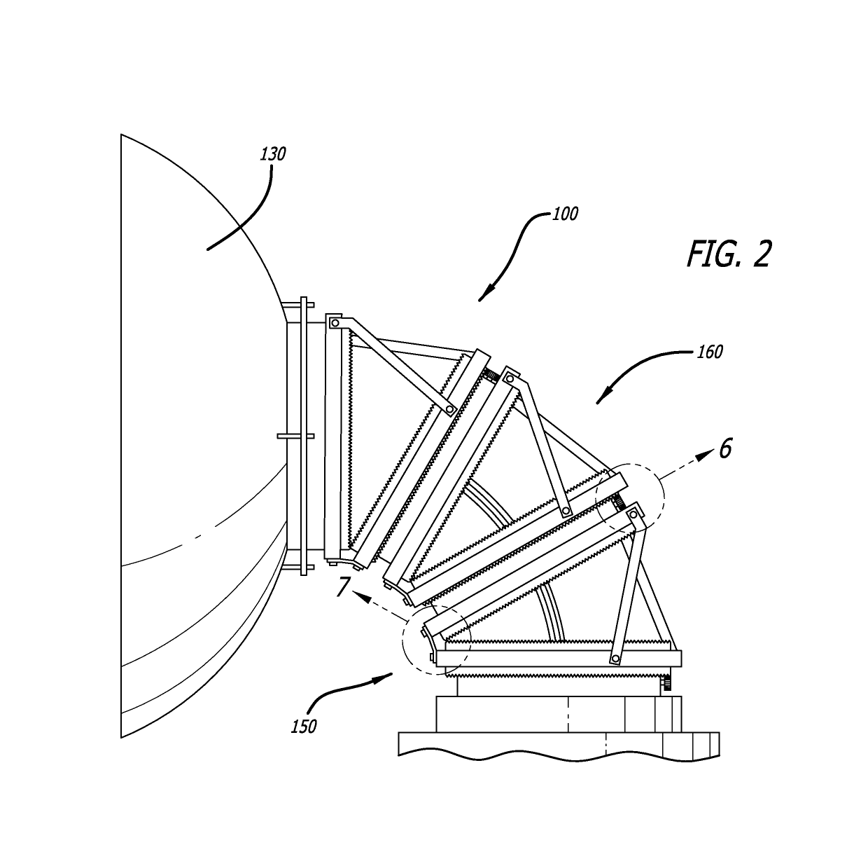

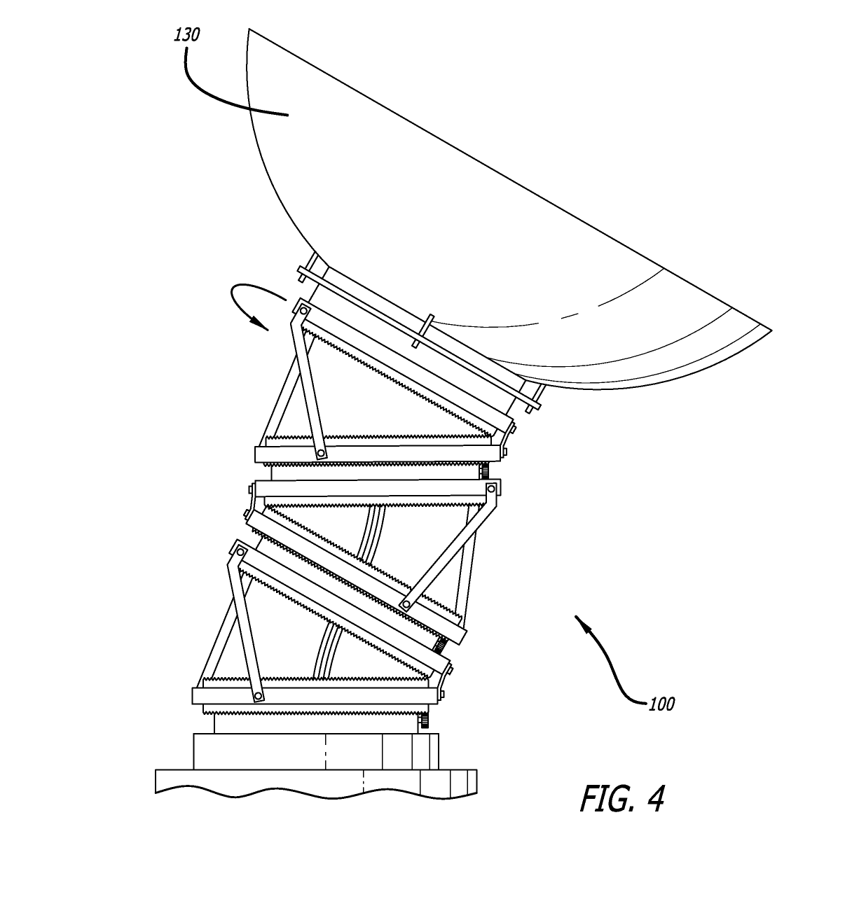

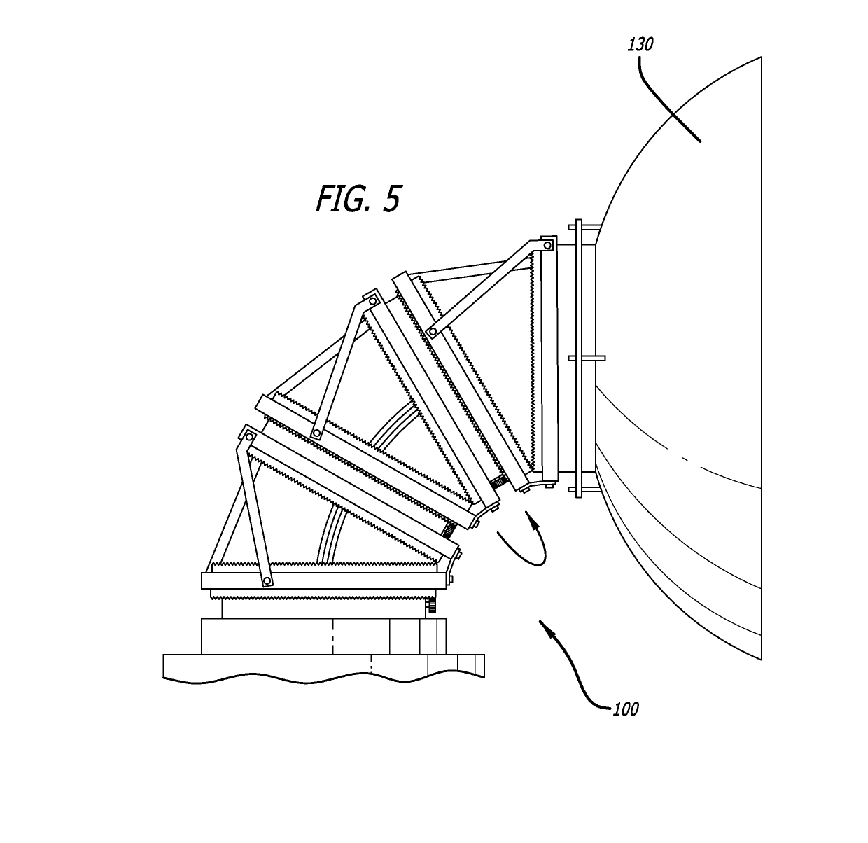

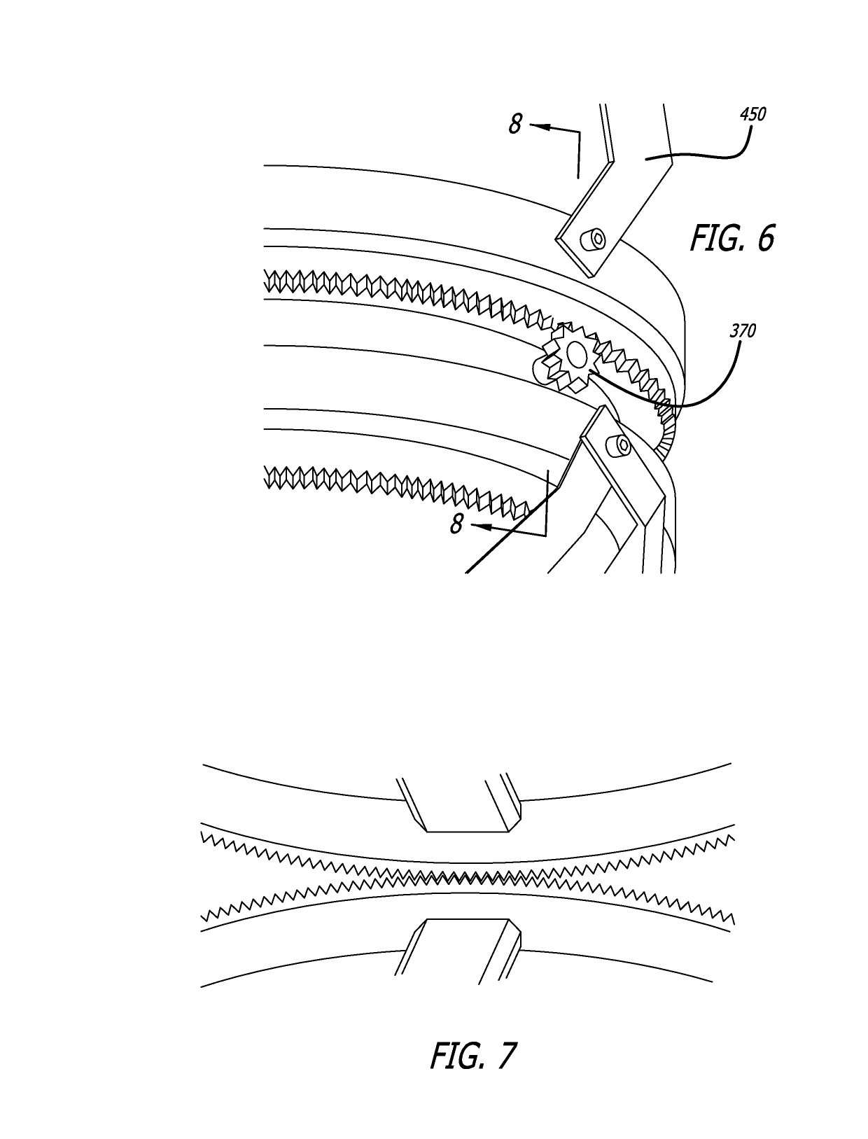

Positioning apparatus 100 includes a wedge assembly shown generally at 150 and a rod assembly shown generally at 160 positioned within the wedge assembly. A flexible protective sleeve 170 can be provided as shown in FIG. 1B. (The sleeve 170 is removed/omitted in FIGS. 2-5, for example, for illustrative purposes.)

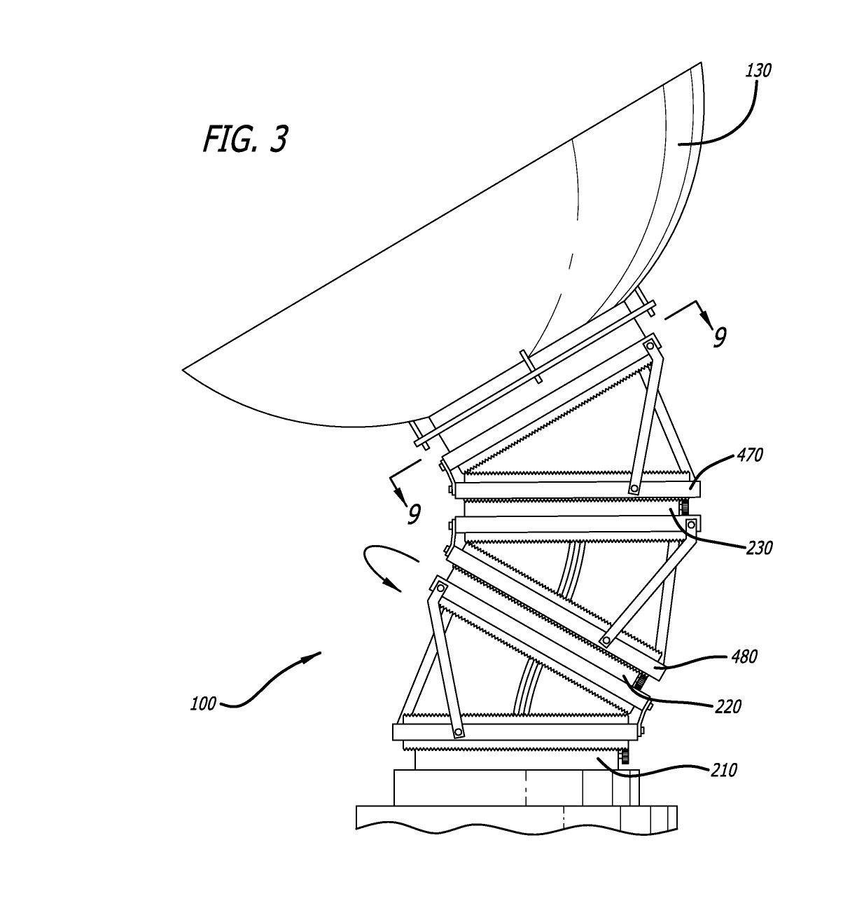

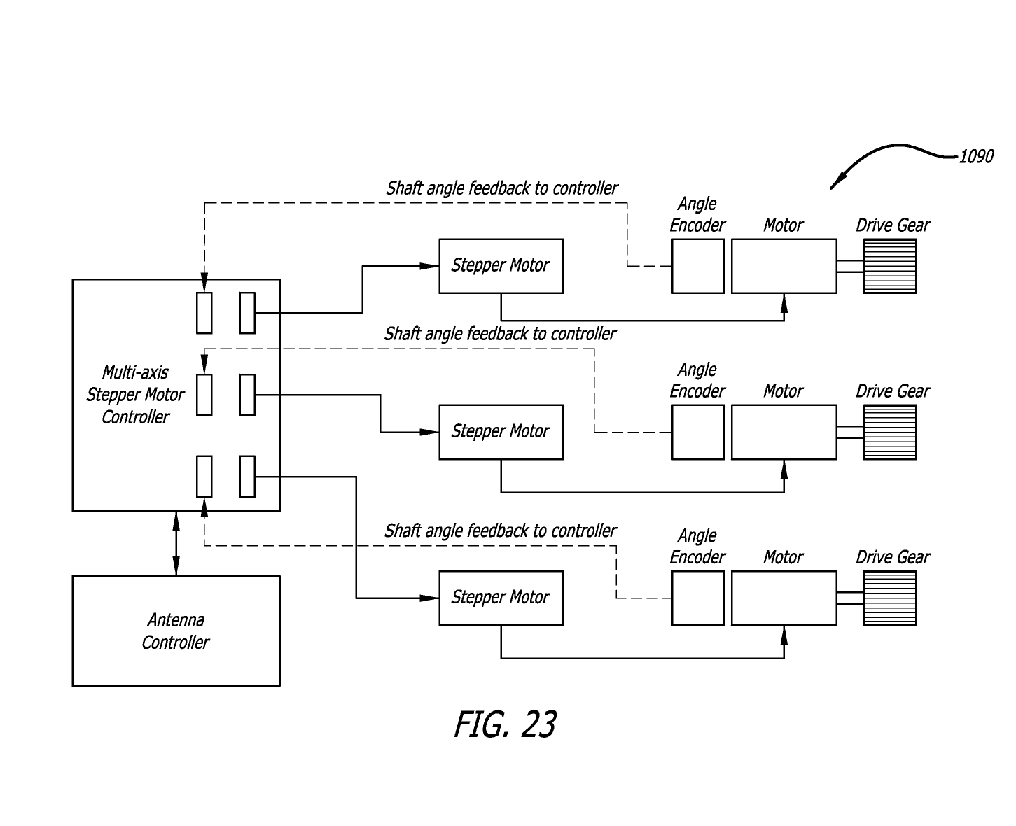

Wedge assembly 150 includes three wedges, namely a bottom wedge 180, a middle wedge 190 and a top wedge 200. Each wedge can have an angle of thirty-five degrees. They are serially connected, as shown generically in FIGS. 1D and 1E. Each wedge 180, 190, 200 is controllably rotatable by its respective motor, namely bottom motor 210, middle motor 220 and top motor 230 (FIG. 23), respectively. The bottom wedge 180 is rotatable relative to the support for the positioning apparatus 100 and when it is rotated the middle and top wedges 190, 200 rotate with it. This can be understood when comparing FIGS. 1D and 1E, and FIGS. 2 and 3. The middle wedge 190 is rotatable relative to the bottom wedge 180 and the top wedge 200 rotates with it. See the arrow in FIG. 3. This movement can be understood from FIGS. 1D and 1E, which show the movement of the payload.

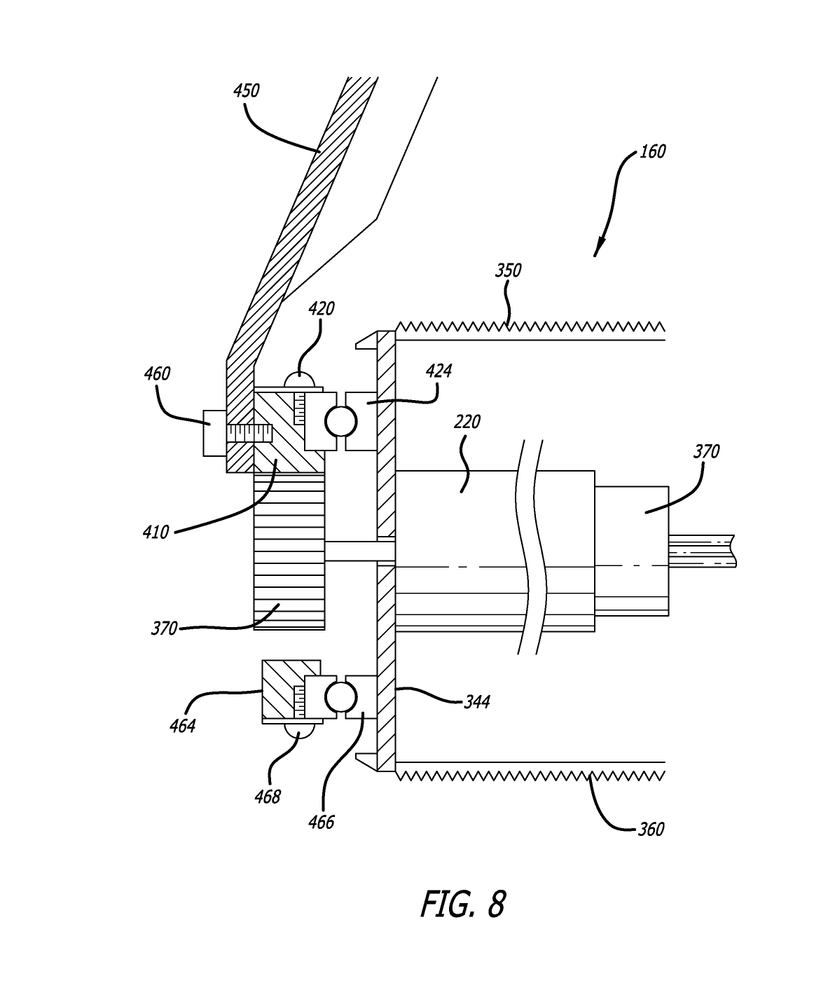

The wedges can include discs, braces connecting the discs together, bearing collars held by the discs and supporting a respective portion of the rod assembly, as described in greater detail with respect to FIG. 8.

The angular positioning apparatus 100, or more particularly the wedge assembly 150, can be understood by referencing FIG. 1C. This figure shows the set of angles described by upper surface of the bottom wedge 180 as it rotates on its support surface. Line 240 is the axis of rotation of the bottom wedge 180, which is perpendicular to the support surface/ground. Line 250 is the axis of rotation of the middle wedge 190, which can lie at any position along a cone formed by the upper surface of the bottom wedge 180. Line 260 is the axis of rotation of the top wedge 200, which can lie at any position along a cone formed by an upper surface of the middle wedge 190. The payload 130 can be positioned anywhere along the cone formed by the upper surface of the top wedge 200, as shown by circle 270. As can thereby be understood, by controlling the angular position of the three wedges, the position of the payload 130 can be placed anywhere in a hemisphere of coverage.

In other words, FIG. 1C shows the interrelationship of the wedges. Each of the upper wedges rotates about an axis that is perpendicular to the upper face of the wedge immediately below, and the lowest wedge (bottom wedge 180) rotates about an axis 240 that is perpendicular to the surface on which the positioner is fastened. The angular positioning possibilities for each axis is a set of angles that form a cone whose axis coincides with a line that is perpendicular to the surface on which it is mounted; and with a vertex angle that is twice the wedge angle.

Thus, FIG. 1C demonstrates that accumulation of wedges with specific angular orientation to each other can be used to steer the angular position of the top surface of uppermost wedge. If that surface carries a “payload” such as a camera or an antenna, then the pointing angle of that payload will be controlled correspondingly.

The coordinate system, the axis perpendicular to the upper surface of each stage can be thought of as creating a cone, which can be described as the rotation of one line around a second intersecting line, which is its axis of rotation. The vertex is the intersection of the two lines. The first stage sits with the vertex on the ground and its axis of rotation perpendicular. The second stage has its axis of rotation lying on the cone formed by the first stage, with its vertex at the same point as that of the first. The orientation of the second axis depends only on the angle of the first stage. The second stage can be envisioned as a conical spinning top that is precessing around a vertical line, and at an angle that is the tilt angle of the first stage (thirty-five degrees, for example). Similarly for the third stage, a cone but with it axis lying on the cone made by the second stage, with its vertex at the same point as the first two stages. The orientation of the third stage is thus dependent on the positions of the first two stages. And the pointing angle of the pedestal is the line perpendicular to the unattached surface of the last stage, and is the composite angle formed by the position of all three stages.

FIG. 8 is a cross-section of a detail of the middle motor 220 of the assembly and its mounting arrangement. Referring thereto, the motor 220 is mounted to a rod segment (torque tube segment) 344 (of the rod assembly 160). The gearing for meshing this torque tube segment 344 with the torque tube segment above it is shown at reference numeral 350. And reference numeral 360 shows the gearing for meshing with the adjacent bottom torque tube segment.

The pinion gear 370 driven by the drive motor 220 is on the outside of the torque tube segment 344. The position encoder 380 can be mounted to the end of the drive motor 220. The pinion gear 370 meshes with a ring gear 400. The ring gear 400 can be formed by a lower surface of a collar 410. A fastener 420 secures the bearing to the collar, the bearing 424 being sandwiched between the bearing collar and the torque tube segment.

The wedge can include a support brace 450, which is secured to the collar 410 by a fastener 460. A bearing collar 464 is secured to a bearing 466 between the collar and the torque tube 344 by a fastener 468. The support brace 450 interconnects two bearing collars of the wedge.

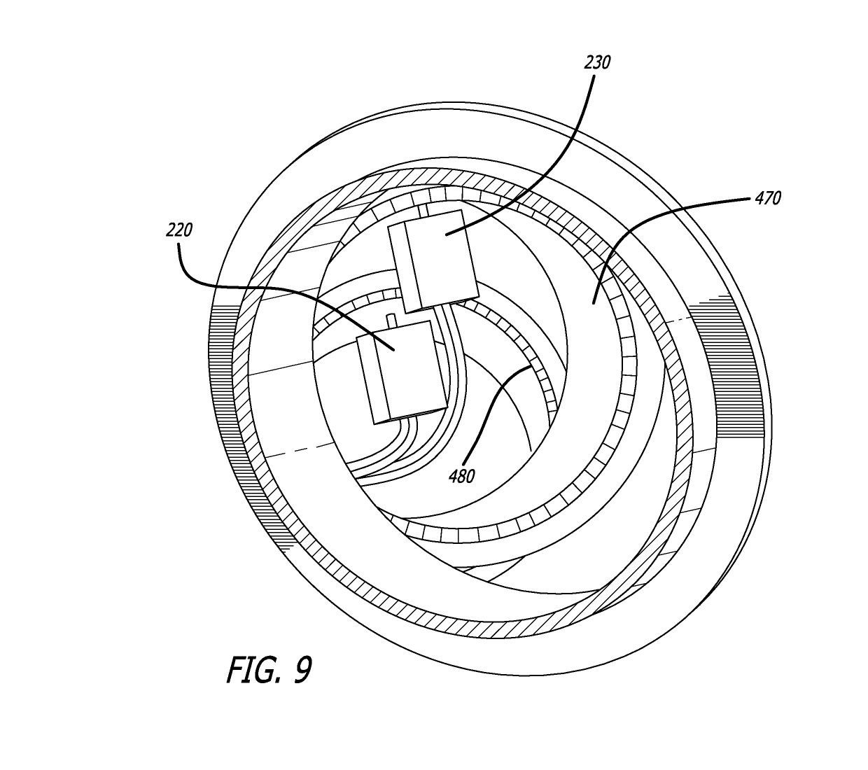

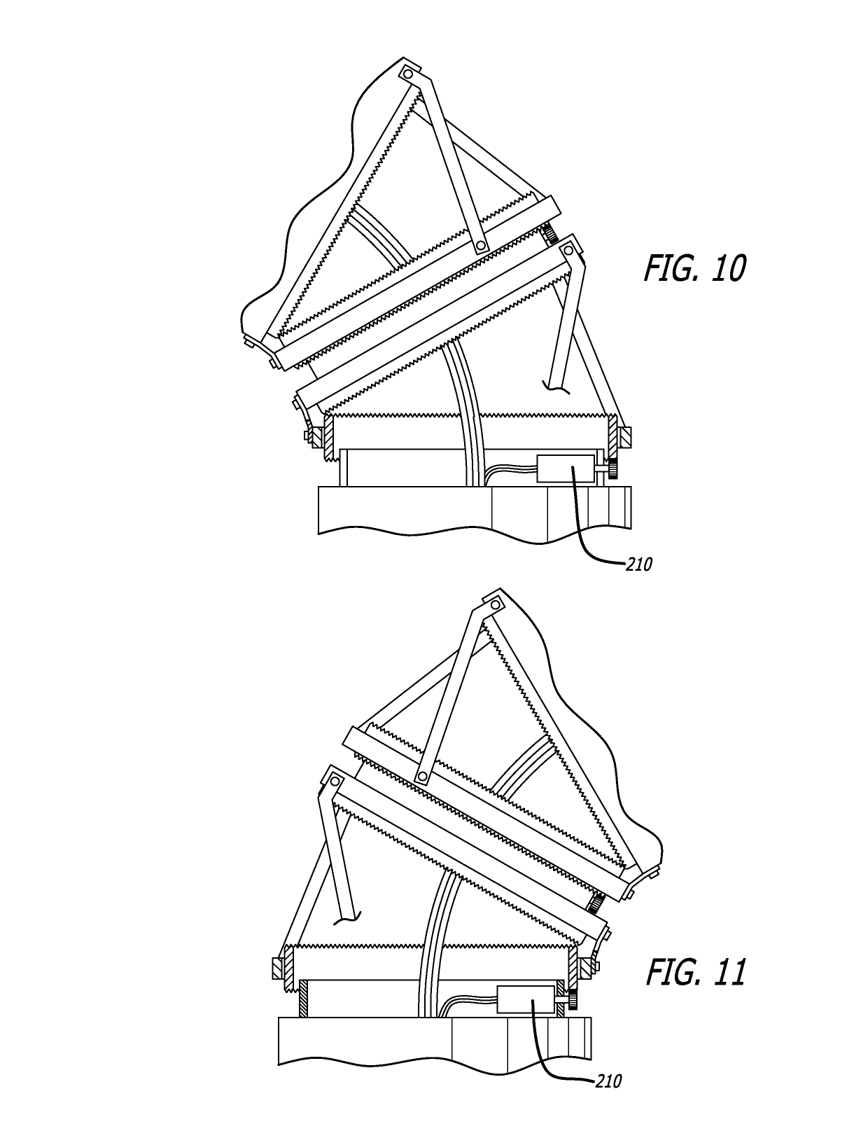

To help understand FIG. 9, the motors 230, 220 correspond to the motors 230, 220 in FIG. 3, and the rings 470, 480 correspond to the rings 470, 480 in FIG. 3. A non-rotating path or tunnel through the apparatus for wires, cables and the like is formed as can be understood from FIG. 9.

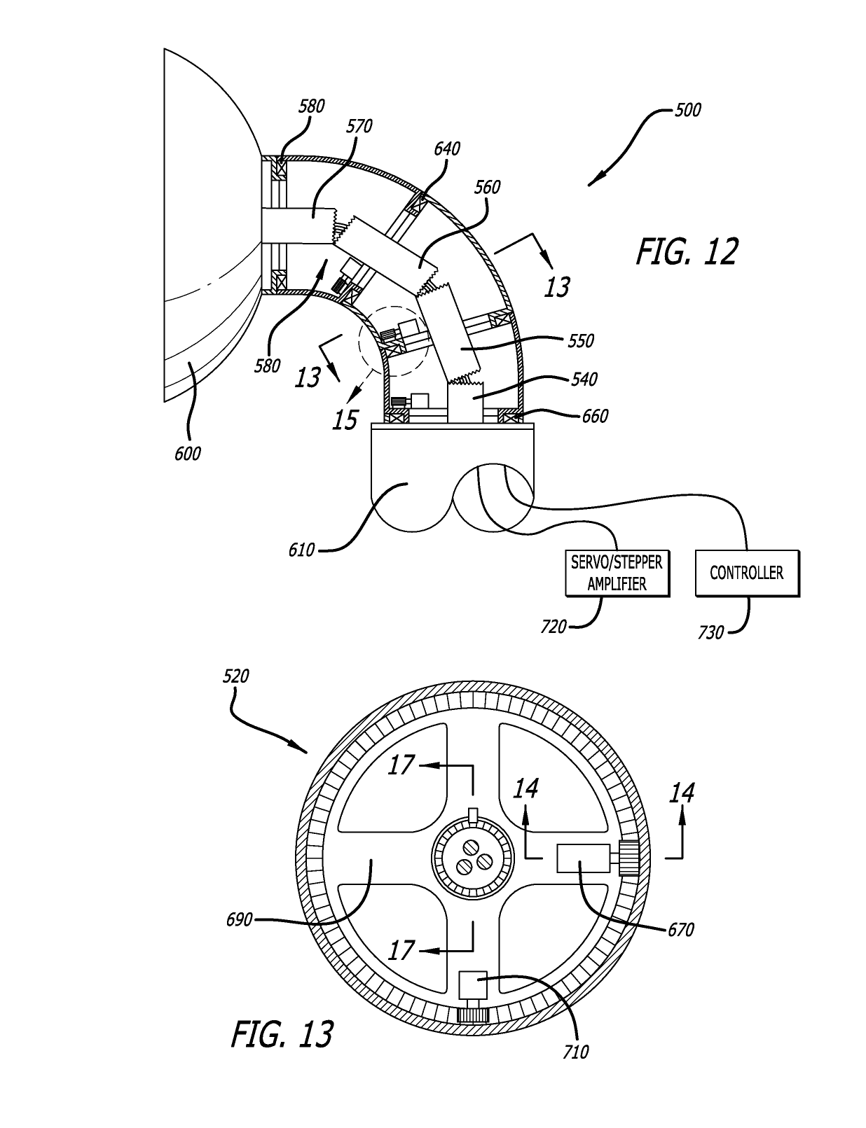

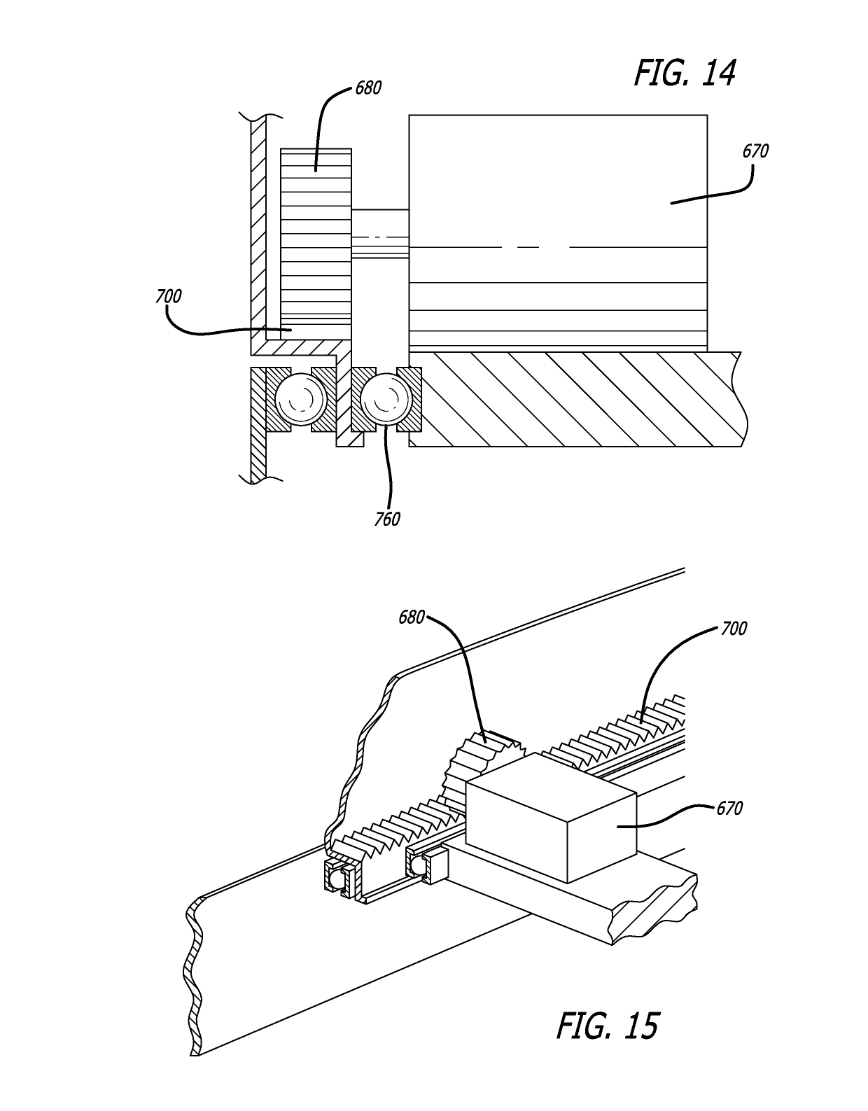

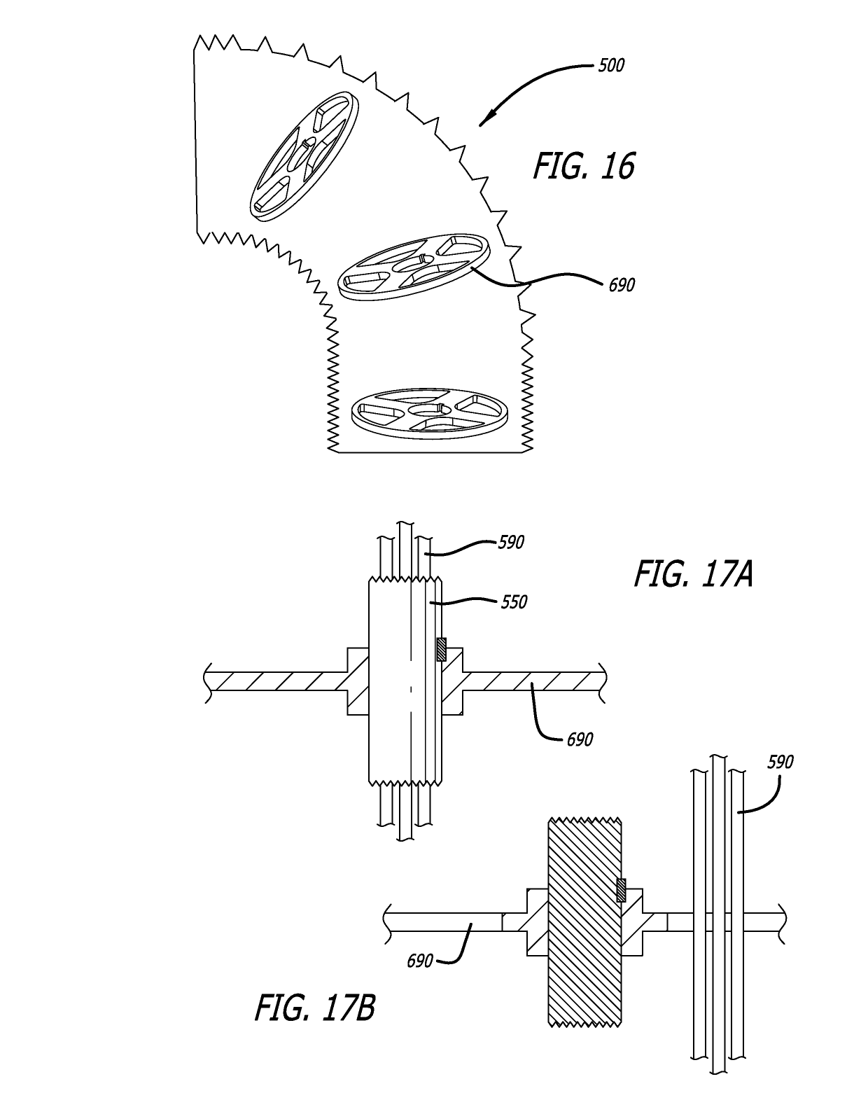

A second embodiment of the positioning apparatus of the disclosure is shown in FIGS. 12 (and 13-17B) generally at 500 and includes a wedge assembly shown generally at 510 and a rod assembly shown generally at 520. The rod assembly can include torque tube segments 540, 550, 560, 570, which form a torque tube 580 that can function as a tunnel for the wire bundle and/or waveguide 590 to travel from the payload 600 to the ground (a station support structure pedestal riser base) 610. The payload 600, an antenna for illustration purposes only, is attached to the uppermost wedge 570 through a bearing 580. The wedges 630 are also secured to their neighboring wedge through a bearing 640, and the lowermost wedge 650 is also fastened to the stationary support structure 610 through a bearing 660.

A motor 670 with a shaft gear 680 is attached to a radial support structure or wheel 690, and drives a crown gear or inside gear 700 that is attached to the wall of the neighboring wedge.

The angular position of the wedge is read by a feedback device 710, which is also attached to the radial support wheel 690. It can use an anti-backlash gear train that is driven by the crown gear or inside gear 700 and accurately reports the unambiguous angular position, or a relative position that can be readily dis-ambiguated by a servo-amplifier 720 and/or controller 730 (FIG. 12). Other viable means of driving and reporting the position of a rotating body relative to another point or plane whether it is moving or stationary as would be apparent to those skilled in the art from this disclosure are within the scope herein.

In embodiment 500, all components enjoy the freedom of direct connections amongst themselves through ordinary, appropriate connection media 740 such as, but not limited to wires, multi-axial cables, flexible waveguides and optical fiber regardless of whether the components are affixed to the payload 600, the stationary support structure 610, the radial support structure 690 or somewhere in between.

The torque tube 580 can affix the payload 600 in an angular sense to the stationary support structure 610. Angular stasis of the payload 600 with respect to the stationary support structure 610 is preserved through the use of torque tube segments whose diameter can be set by the requirements of the connection media. The torque tubes segments are supported within the wedges by their radial support wheel 690 and bearing 760. Meshing bevel gears can keep the torque tube segments in a single angular orientation with respect to each other as well as the stationary support structure.

The motors and optical encoders (or other means of position feedback) are not affixed to the wedges in the first and second embodiments. Rather, they are mounted to an independent structure that can lie concentric to and within the wedges and does not turn with respect to the ground (or other mounting surface). The wedges are therefore propelled not with respect to the neighboring wedge, but rather relative to this inner structure, namely the “torque tube” or “torque shaft.” Thereby, the torsionally-stationary inner structure advantageously provides that the positioning of the payload is not constrained by its connections to equipment that is located on the ground or other mounting surface.

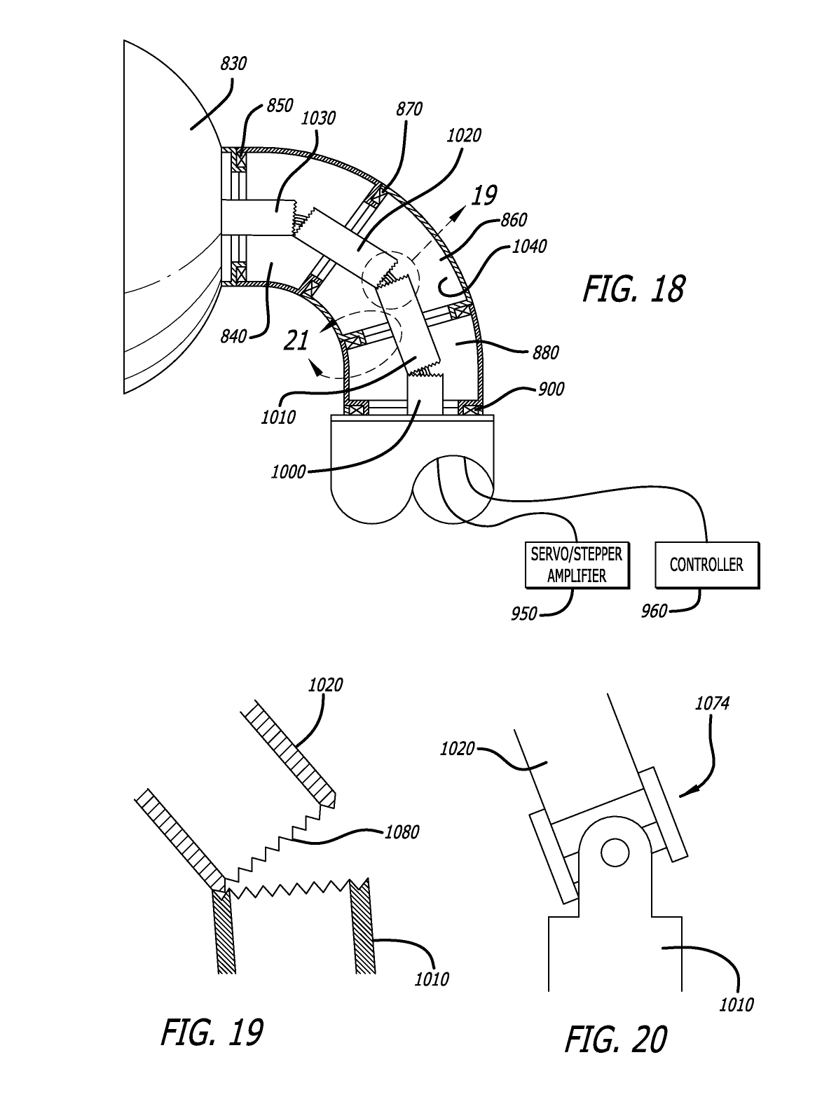

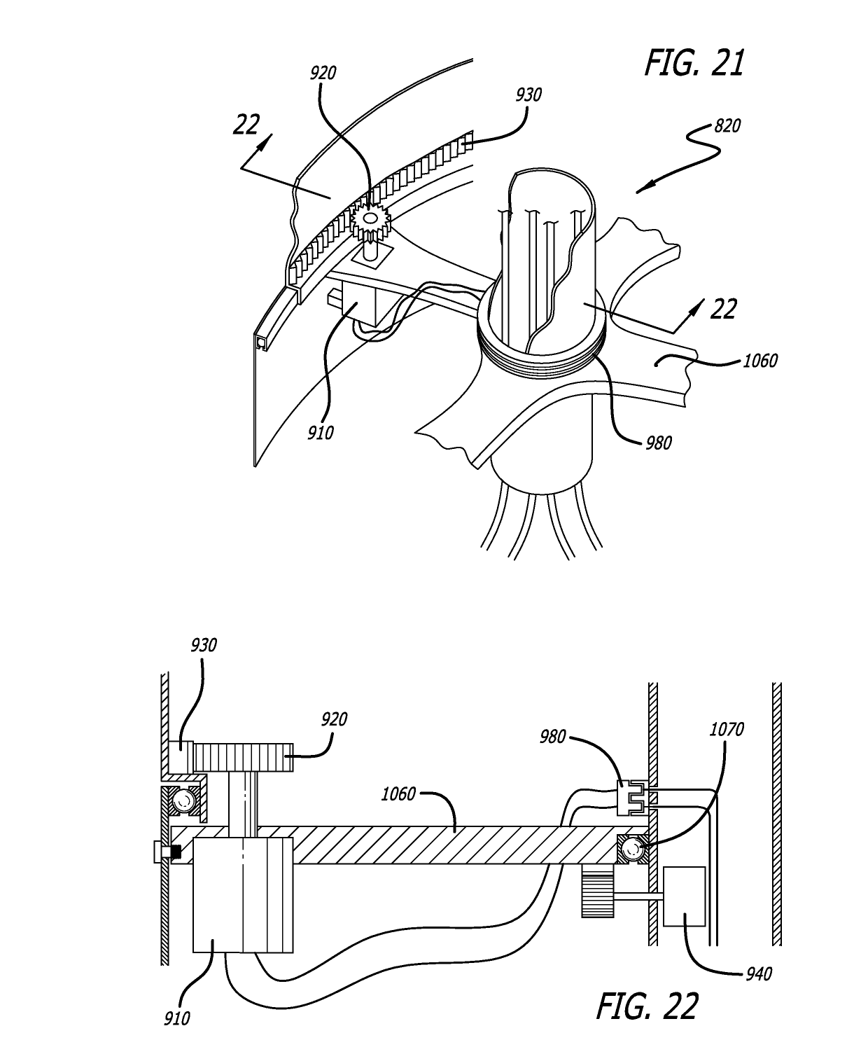

A third embodiment of the positioning apparatus of the present disclosure is illustrated in FIG. 18 generally at 800 and includes a wedge assembly shown generally at 810 and a rod assembly shown generally at 820. The payload 830, an antenna for illustration purposes only, is attached to the uppermost wedge 840 through a bearing 850. The wedges 860 are also secured to their neighboring wedge through a bearing 870, and the lowermost wedge 880 is also fastened to the stationary support structure 890 through a bearing 900. A motor 910 with a shaft gear 920 is attached to the wall of each wedge, and drives an inside gear 930 that is attached to the wall of the neighboring wedge.

The angular position of the wedge can be read by a feedback device 940, which may employ an anti-backlash gear train that is driven by the inside gear 930 and accurately reports the unambiguous angular position, or a relative position that can be readily dis-ambiguated by the servo-amplifier 950 and/or controller 960 (FIG. 18).

Other means of driving and reporting the position of a rotating body relative to another point or plane whether it is moving or stationary as are apparent to those skilled in the art from this disclosure are within the scope hereof. In this embodiment, the connections from the motors 910 and the position feedback devices 940 may use slip-rings 980 to transport them to the servo-amplifier 950 and/or controller 960.

The payload and the source/terminus enjoy the freedom of a direct connection through ordinary, appropriate connection media such as, but not limited to wires, multi-axial cables, flexible waveguides and optical fiber when the source and/or terminus is mounted to the stationary support structure.

The rod assembly can include four segments 1000, 1010, 1020, 1030 (FIG. 18) that form a torque tube 1040, which acts as a tunnel for the wire bundle and/or waveguide to pass from the payload to the ground. Additionally, the torque tube 1040 prevents the connection media from absorbing the stress of torque that may be inadvertently imparted on the payload by the rotating wedges. The torque tube acts as a shaft to affix the payload in an angular sense, to the stationary support structure on which the positioner is mounted. Angular stasis of the payload with respect to the stationary support structure is preserved through the use of torque tubes, similar to those described in other embodiments discussed earlier.

The torque tube segments 1000, 1010, 1020, 1030 are supported within the wedges by radial support wheel 1060 and a tube support bearing 1070, and Universal joints as seen in FIG. 20 at 1074 or constant-velocity (CV) joints such as those used in automobile drive systems may be employed to preserve torsional stasis through the torque tube segments 1000, 1010, 1020, 1030.

When the connection medium between the payload and the source/terminus includes a flexible waveguide, the torque tube segment diameters may be increased as desired. When diameters greater than three inches are required for the torque tube, Universal Joints or CV joints may be replaced by meshing bevel gears 1080 as seen in FIG. 19.

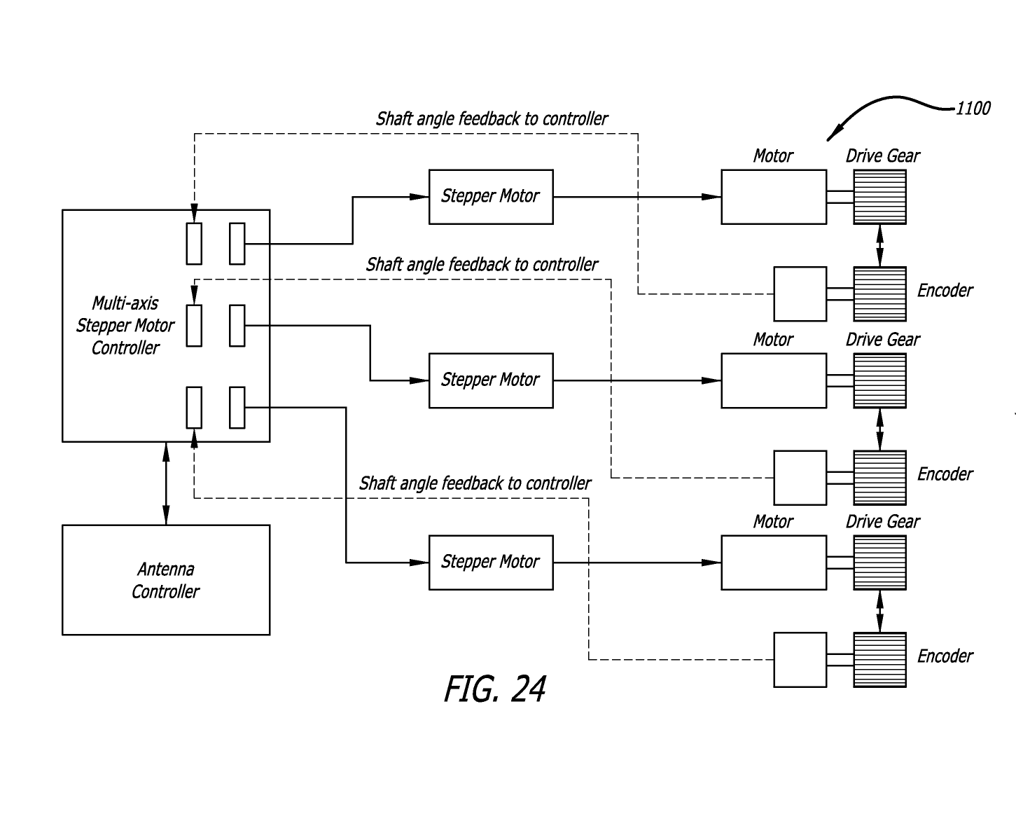

Electrical schematics of the embodiments are shown in FIGS. 23 and 24 at 1090 and 1100, respectively.

Thus, the present rotating (antenna) positioner apparatus 100 which uses a non-rotating tube does not have the problem of carrying signals and power cables through a rotating axis, and thus electronic equipment that is rotating with respect to the ground can continue functioning while the positioner is rotating, without placing limits on the rotation. Also, the present apparatus does not accomplish this through the use of “rotary joints” and “slip-rings” (though a slip ring can be used in the third embodiment) that are designed to carry radio frequency and control signals, respectively. Rotary joints and slip-rings are expensive components of a positioning system, and also form the weak link of the mechanical positioning system due to their fragility and the reliability with which they must perform due to the nature of the information that they carry.

A problem with carrying signals through rotary joints is associated signal loss, but this not a problem with the present angular positioning apparatus as it does not use a rotary joint. This becomes a problem when large amounts of Radio Frequency (RF) power need to be transferred from the location of the transmitter, which is usually on the ground, to the feed of the dish, which moves with the dish. Each time signals pass through rotary joints, approximately 10% to 20% of the RF power is lost due in the mechanics of the rotary joint. This lost power is dissipated as heat, which becomes significant when the transmitter is producing large amounts of power. For example, when one Kilowatt of power is being generated, approximately 300 W is lost as heat simply by going through two rotary joints. In general, the cost of transmitters quadruples for every doubling of the output power.

The present apparatus also does not limit the amount of continuous rotation that can be achieved by the pedestal, thus allowing an ordinary set of cables and transmission lines to carry the required signals to and from the rotating parts. This limitation can affect the envelope of operational capability and limits the variety of missions for which the pedestal can be used.

By using three axes of angular positioning, the present angular positioning apparatus does not suffer from the “keyhole” problem of angular positioners that operate through angular control in two axes of angular movement. A two-axis positioner inevitably has at least one “keyhole” within its hemisphere of coverage, where there are a multitude of positions in one of the two axes associated with a single pointing angle for the antenna. A keyhole appears along the one of the two axes of rotation. A keyhole in coverage is most injurious to the function of the positioner when the antenna is tracking a target that comes close to, but does not pass through this keyhole. During such encounters, the antenna has to move rapidly through a large angular extent in order to keep up with relatively small angular motion of the target near the keyhole. In at least one vernacular, this process is called a “keyhole maneuver.” The consequence of this basic keyhole problem is that in order to reliably track a target through any angular position, the keyhole maneuver usually dictates the acceleration and velocity performance requirements for the pedestal.

Although the present inventions have been described in terms of preferred and alternative embodiments above, numerous modifications and/or additions to the above-described embodiments would be readily apparent to one skilled in the art. The embodiments can be defined as methods of use carried out by anyone, any subset of or all of the components and/or users; as systems of one or more components in a certain structural and/or functional relationship; and/or as subassemblies or sub-methods. The inventions can include each of the individual components separately. However, it is intended that the scope of the present inventions extend to all such modifications and/or additions and that the scopes of the present inventions are limited solely by the claims set forth herein.

The terminology used herein is for the purpose of describing particular example embodiments only and is not intended to be limiting. As used herein, the singular forms “a,” “an” and “the” may be intended to include the plural forms as well, unless the context clearly indicates otherwise. The terms “comprises,” “comprising,” “including” and “having” are inclusive and therefore specify the presence of stated features, integers, steps, operations, elements and/or components, but do not preclude the presence or addition of one or more other features, integers, steps, operations, elements, components and/or groups thereof. The method steps, processes and operations described herein are not to be construed as necessarily requiring their performance in the particular order discussed or illustrated, unless specifically identified as an order of performance. It is also to be understood that additional or alternative steps may be employed.

Although the terms first, second, third and so forth may be used herein to describe various elements, components, regions, layers and/or sections, these elements, components, regions, layers and/or sections should not be limited by these terms. These terms may be used to distinguish one element, component, region, layer or section from another region, layer or section. Terms such as “first,” “second” and other numerical terms when used herein do not imply a sequence or order unless clearly indicated by the context. Thus, a first element, component, region, layer or section discussed below can be termed a second element, component, region, layer or section without departing from the aspects of the present teachings.

When an element or layer is referred to as being “on,” “engaged to,” “connected to” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (such as “between” versus “directly between,” and “adjacent” versus “directly adjacent”). As used herein, the term “and/or” includes any and all combinations of one or more of the associated listed items.

Spatially relative terms, such as “inner,” “outer,” “beneath,” “below,” “lower,” “upper,” “above,” “forward,” “top,” “bottom,” and “rearward,” may be used herein for ease of description to describe one element's or feature's relationship to another, but the disclosure is intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated ninety degrees or at other orientations) and the spatially relative descriptors used herein interpreted accordingly.

What is claimed is:

1. An angular positioning apparatus, comprising:
a wedge assembly including a plurality of serially connected wedges; the bottommost of the wedges being rotatable relative to a support for the positioning apparatus, and each of the rest of the wedges being rotatable relative to the wedge directly beneath it; and
a rod assembly positioned generally within the wedge assembly; the rod assembly being connected to the wedge assembly such that (a) a distal end of the rod assembly has an operative pointing direction movable by the wedge assembly and corresponding to a pointing direction of a distal end of the wedge assembly as one or more of the wedges are rotated and positionable through all angles within a solid angle and (b) the rod assembly does not twist about a longitudinal axis thereof as the wedges are rotated.

2. The angular positioning apparatus of claim 1 wherein the rod assembly defines a tube through which wires and/or cables of the positioning apparatus pass.

3. The angular positioning apparatus of claim 1 wherein the rod assembly defines a solid shaft.

4. The angular positioning apparatus of claim 1 wherein the rod assembly defines a torque tube that provides torsional stasis between a payload operatively attached to the angular positioning apparatus and a stationary mounting surface of the positioning apparatus.

5. The angular positioning apparatus of claim 1 wherein the rod assembly defines a torque tube that houses electrical, optical and/or electromagnetic connection media on its path between a payload of the angular positioning apparatus and a source/terminus.

6. The angular positioning apparatus of claim 1 wherein the rod assembly is configured to support at a distal end thereof a payload such that the angular position of the payload is determined by the pointing direction of the distal end, which is controlled by the wedge assembly.

7. The angular positioning apparatus of claim 6 wherein the payload is an antenna, a camera, a laser or other angular sensitive device.

8. The angular positioning apparatus of claim 1 wherein the wedge assembly includes a plurality of drive motors, each positioned to rotate a respective one of the wedges and each of the drive motors not rotating relative to the longitudinal axis during the rotation of each of the wedges.

9. The angular positioning apparatus of claim 1 wherein the rod assembly includes a plurality of serially-connected rod segments, each connected to an adjacent one of the rod segments so as to allow relative motion only about a local set of Cartesian axes.

10. The angular positioning apparatus of claim 9 wherein a motor is mounted to one of the rod segments and rotatably drives an upper wedge with respect to the one of the rod segments.

11. The angular positioning apparatus of claim 10 wherein a bearing collar is positioned between the upper wedge and the one of the rod segments.

12. The angular positioning apparatus of claim 9 wherein the rod assembly includes a rod and a bracket holding the rod, and wherein a motor is mounted on the bracket and is positioned to drive one of the wedges relative to the bracket.

13. The angular positioning apparatus of claim 12 wherein the rod is a tube through which wires, cables or other transmission media pass.

14. The angular positioning apparatus of claim 9 wherein the wedge assembly includes a support bracket that keeps one of the rod segments centered, the support bracket is secured to a lower one of the wedges and is rotatable about a rod of the rod assembly and a motor mounted to the support bracket and driving an upper one of the wedges with respect to the lower one of the wedges and the one of the rod segments.

15. The angular positioning apparatus of claim 9 wherein bearings are positioned between one of the rod segments and one of the wedges.

16. The angular positioning apparatus of claim 1 further comprising a plurality of devices each for recording the angular position of a respective one of the wedges with respect to the torque tube or shaft.

17. The angular positioning apparatus of claim 16 wherein the devices are encoders.

18. The angular positioning apparatus of claim 1 wherein the rod assembly defines a torque tube centered within the wedge assembly and being dimensioned and configured to support the torque needed for the necessary payload dynamics and/or to contain the wires, cables and/or transmission media to be transported within.

19. The angular positioning apparatus of claim 1 wherein the rod assembly forms a torque tube supported by a bearing, and is configured and adapted for a payload to be attached directly thereto.

20. The angular positioning apparatus of claim 1 wherein a payload is attached to the uppermost one of the wedges through a bearing.

21. The angular positioning apparatus of claim 1 wherein the rod assembly defines a tube and wherein a motor rotates with one of the wedges and drive motors for the wedge assembly have wiring that passes via a slip ring into the tube.

22. The angular positioning apparatus of claim 1 wherein the wedge assembly and the rod assembly have unrestricted motion in all axes of rotation and are free of a rotary joint or a slip ring to carry electrical, optical and/or electromagnetic signals between a payload and a source/terminus of the positioning apparatus.

23. The angular positioning apparatus of claim 1 wherein each of the wedges includes discs, braces connecting the discs together, bearing collars held by the discs and supporting a respective portion of the rod assembly.

24. The angular positioning apparatus of claim 23 wherein the rod assembly defines a torque tube and gearing associated therewith.

25. The angular positioning apparatus of claim 1 wherein the rod assembly defines a torque tube that is connected to the wedges via bearings so that the torque tube flexes generally in the same direction as the wedges but does not rotate with them.

26. The angular positioning apparatus of claim 1 wherein the rod assembly defines a torque tube and the wedge assembly positions the torque tube to the desired angle.

27. The angular positioning apparatus of claim 1 wherein the wedges are securely and rotatably attached to a torque tube of the rod assembly including at a payload terminus location.
